(19) United States
(12) Patent Application Publication
(10) Pub. No.: US 2021/0120822 A1
(43) Pub. Date: Apr. 29, 2021

(54) EFFECTIVE ANTIBACTERIAL HYDROPHILIC PHOSPHONIUM POLYMERS WITH LOW HEMOLYTIC ACTIVITY

(71) Applicant: THE UNIVERSITY OF WESTERN ONTARIO, London (CA)

(72) Inventors: Tyler J. CUTHBERT, Port Moody (CA); John Frederick TRANT, LaSalle (CA); Elizabeth Rachel GILLIES, London (CA); Paul Joseph RAGOGNA, Stratford (CA)

(21) Appl. No.: 16/617,364

(22) PCT Filed: May 28, 2018
(86) PCT No.: PCT/CA2018/050621

§ 371 Date: Nov. 26, 2019

Related U.S. Application Data
(60) Provisional application No. 62/511,821, filed on May 26, 2017.

(51) Int. Cl. A01N 57/34; C08F 30/02

(52) U.S. Cl. CPC A01N 57/34; C08F 2438/03; C08F 30/02

(57) ABSTRACT

This disclosure provides phosphonium polymers with increased hydrophilicity exhibiting increased antibacterial activity and decreased hemolytic activity. These phosphonium polymers include Poly(THPvbPCl) poly(tris(3-hydroxypropyl)(vinylbenzyl)phosphonium chloride) and derivatives thereof, ((2,3,4,6-Tetra-O-acetyl-manno-pyranyl)-1-oxy-allyl and derivatives thereof, and poly(dihexyl(2,3,4,6,-hydroxy-gluco-pyranyl)-1-oxy-propyl)vinylbenzylphosphonium chloride) and derivatives thereof.

### FIELD

The present disclosure relates to phosphonium polymers with increased hydrophilicity exhibiting increased antibacterial activity and decreased hemolytic activity.

### BACKGROUND

Synthetic antibacterial polyelectrolytes containing ammonium or phosphonium functional groups have been widely investigated due to their increased activity as compared to their monomeric components. Many different nitrogen-containing polycations have been reported including polyammonium, polyimidazolium, polybiguanide, and polypyridinium salts. Antibacterial polymers have been synthesized as side chain ammonium functionalized synthetic linear polymers, dendrimers, and biopolymers such as chitosan. Along with the ionic groups, most active antibacterial polyelectrolytes possess alkyl chains that result in amphiphilic structures that have affinity for negatively charged bacterial cell walls. It is hypothesized that these units kill bacteria by damaging the cell membrane, causing permeabilization and leakage of cell contents, see reference¹.

The balance of hydrophilicity-hydrophobicity for antibacterial polymers is one that has been explored by varying cationic:hydrophobic ratios. This can be completed by using copolymers with separate hydrophilic (cations) and hydrophobic (alkyl chain) components as shown in the molecule on left hand side of FIG. 1, or by having the hydrophilic and hydrophobic components within the same comonomer as illustrated by the molecule on the right hand side of FIG. 1. This seemingly subtle change can impart large differences in the antibacterial effectiveness, but also the compatibility to healthy cells, see reference².

Increases in the hydrophobicity of the antibacterial polymer are usually achieved by incorporating linear alkyl chains with increasing chain length. Increasing the alkyl chain length may increase the antibacterial activity but has also been reported to increase the hemolytic activity (lysing of red blood cells) which is detrimental for their potential use in vivo. Far fewer studies have reported an increase in antibacterial activity resulting from increasing the hydrophilicity of antibacterial polymers, see reference³.

The majority of antibacterial polymers have been designed based on the principle of incorporating different hydrophilic (cationic) and hydrophobic (alkyl) components, whereas there are few reports involving other architectures. The polymerization from antibiotic β-lactams was investigated for the preparation of ammonium based antibacterial polymers. Copolymerization with ammonium containing monomers resulted in good antibacterial activity with low hemolysis, see reference⁴.

Alternatively, the use of additives combined with traditional small molecule antibiotics has been explored as a means to increase their effectiveness. For example, the combination of aminoglycosides with sugar-based metabolites resulted in the killing of persistent bacteria (FIG. 2), see reference⁵.

Mannose is known to bind to Escherichia coli (E. coli) adhesins on the pili of the bacteria. The interactions of mannose with E. coli have been used for the labelling of the bacteria with gold nanoparticles and as attachment antagonists because the pili participate in surface colonization, see reference⁶. Mannose has been functionalized with alkylethers and alkylthioethers to achieve bacteriostatic conditions, inhibiting the growth of E. coli at millimolar concentrations, see the formulas in FIG. 2, see reference⁷.

Being able to find polymers with increased hydrophilicity exhibiting increased antibacterial activity and decreased hemolytic activity would be very advantageous in developing antimicrobial products with long lasting efficacy.

The distinction between antimicrobial and antifouling surfaces is clear. Antimicrobial surfaces are designed to kill microbes as they approach the surface. However, this does not mean they are also antifouling as biofilm from dead microbes could indeed accumulate. Antifouling surfaces on the other hand, are designed specifically to prevent the accumulation of live or dead organisms on the surface. Antifouling surfaces are a specifically tailored to repel organisms from the surface. The could also interfere with the make up of a biofilm such that adhesion is prevented. This distinction is very well established in the literature and a comprehensive review on this topic was recently published by Francolini et al. (Antifouling and antimicrobial biomaterials: an overview; Iolanda Francolini, Claudia Vuotto, Antonella Piozzi, Gianfranco Done APMIS/Volume 125, Issue 4; published 13 Apr. 2017).

### SUMMARY

The present disclosure provides a phosphorous based polymer derivative of poly(tris(3-hydroxypropyl)(vinylbenzyl)phosphonium chloride) shown in Formula 1A exhibiting antibacterial properties,

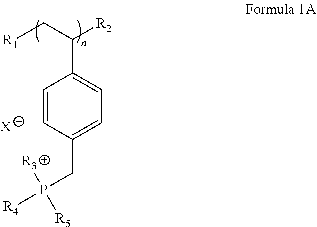

wherein n is an integer in a range from 1 (monomer) to about 300, m is a carbon linker from C₁H₂ to C₁₈H₃₇, wherein R₁ and R₂ are any of RAFT, ATRP, NMP, alkyl, aryl, ester, ether, carboxylic acid, halogen, or a hydrogen substituent, wherein R₃, R₄, R₅ can be any combination of one, two, or three hydroxyl containing substituent with the remaining substituents being any combination of alkyl, aryl, halogen, carboxylic acid, ester, or wherein R₃, R₄, R₅ can be either an alpha or beta anomer with allyl ether, thioether, or propyl linked mannose, glucose, galactose, maltose, or sucrose substituent as one, two, or all three substituents in combination with any alkyl, aryl, halogen, carboxylic acid, ester, and where the anion X⁻ can be any anionic halogen.

A specific example embodiment of the phosphorous based polymer exhibiting antibacterial activity shown in Formula 1A comprises poly(tris(3-hydroxypropyl)(vinylbenzyl)phosphonium chloride) shown in Formula 1,

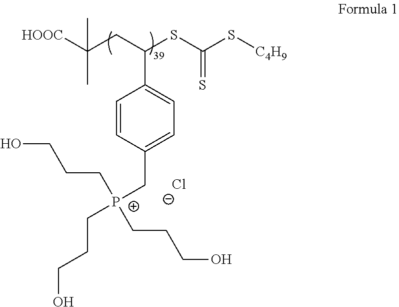

Another specific embodiment of the structure of Formula 1A is a phosphorous based polymer exhibiting antibacterial activity poly(dihexyl(2,3,4,6-hydroxy-mannopyranyl)-1-oxy-propyl)vinylbenzylphosphonium chloride) shown in Formula 2 (which is a mannose version),

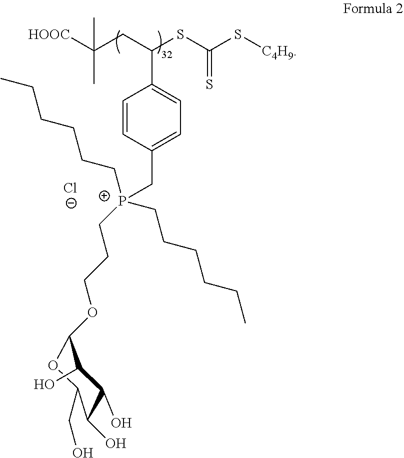

Another embodiment of a phosphorous based polymer exhibiting antibacterial activity comprises poly(dihexyl(2,3,4,6,-hydroxy-gluco-pyranyl)-1-oxy-propyl)vinylbenzylphosphonium chloride) shown in Formula 3 (Glucose derivative),

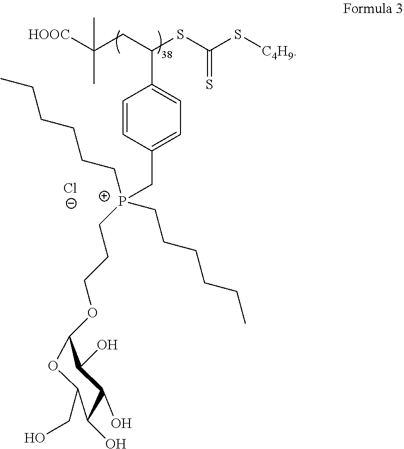

The present disclosure also provides a phosphorous based polymer derivative of poly(tris(3-hydroxypropyl)(acryloyl)phosphonium chloride) shown in Formula 4 exhibiting antibacterial properties

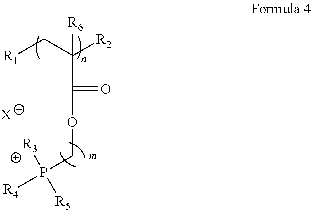

wherein n is an integer in a range from 1 (monomer) to about 300, m is a carbon linker from C₁H₂ to C₁₈H₃₇, wherein R₁ and R₂ are any of RAFT, ATRP, NMP, alkyl, aryl, ester, ether, carboxylic acid, halogen, or a hydrogen substituent, wherein R₃, R₄, R₅ can be any combination of one, two, or three hydroxyl containing substituent with the remaining substituents being any combination of alkyl, aryl, halogen, carboxylic acid, ester, or wherein R₃, R₄, R₅ can be either an alpha or beta anomer with allyl ether, thioether, or propyl linked mannose, glucose, galactose, maltose, or sucrose substituent as one, two, or all three substituents in combination with any alkyl, aryl, halogen, carboxylic acid, ester, and where the anion X⁻ can be any anionic halogen.

A further understanding of the functional and advantageous aspects of the present disclosure can be realized by reference to the following detailed description and drawings.

### BRIEF DESCRIPTION OF THE DRAWINGS

Embodiments will now be described, by way of example only, with reference to the drawings, in which:

FIG. 1 shows an example of hydrophilic-hydrophobic balance by charge-hydrophobic combination vs. separation.

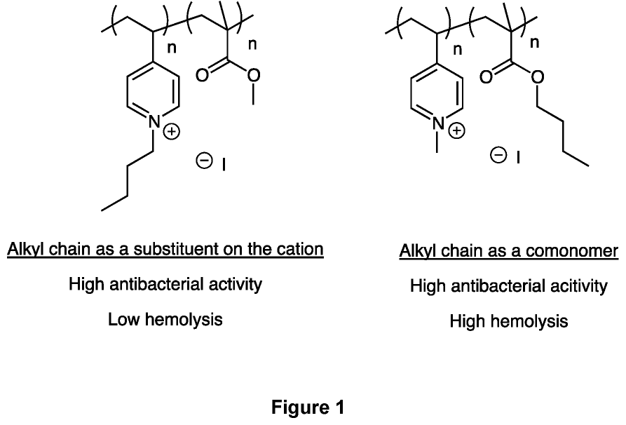

FIG. 2 shows examples of antibacterial approaches produced from the polymerization of β-lactams (left), heightened potency of antibiotics when used in conjunction with metabolites such as mannitol (middle), and antibacterial mannoside-derived glycosides (right).

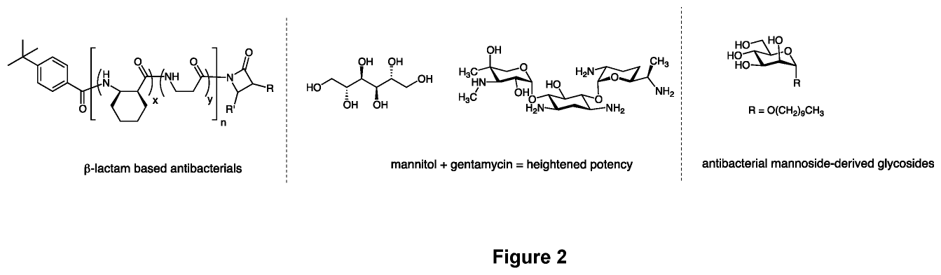

FIG. 3 shows ¹H NMR (600 MHz, D₂O) of Poly(THPvbPCl), Formula 1.

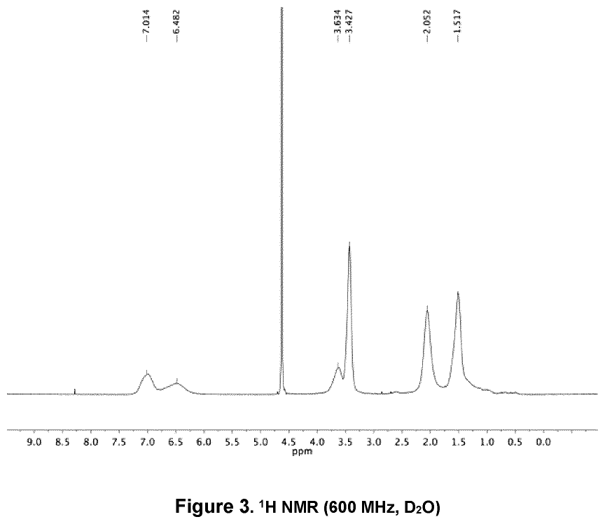

FIG. 4 shows ³¹P{¹H} NMR (400 MHz, D₂O) of Poly(THPvbPCl), Formula 1.

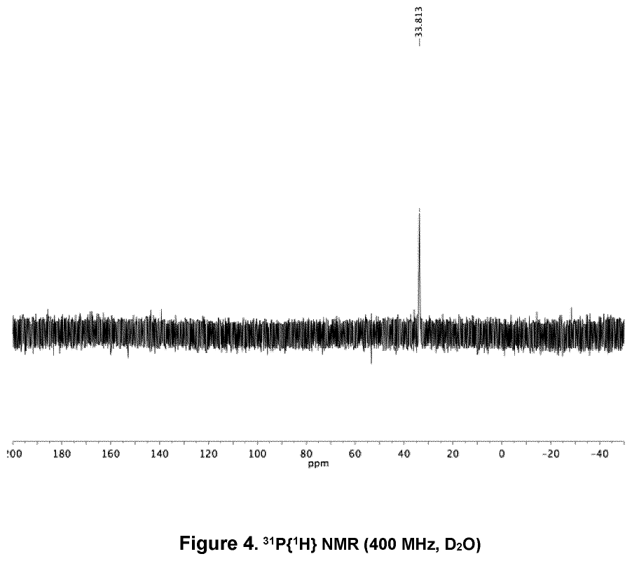

FIG. 5 shows ¹H NMR (600 MHz, D₂O) of Formula 2.

FIG. 6 shows ³¹P{¹H} NMR (400 MHz, D₂O) of Formula 2.

FIG. 7 shows ¹H NMR (600 MHz, D₂O) of Formula 3.

FIG. 8 shows ³¹P{¹H} NMR (400 MHz, D₂O) of Formula 3.

FIG. 9 shows examples of Galactose, Glucose and Mannose derivatives including allyl ethers, allylthioethers, and C-allyl compounds, that may be part of Formulas 2 and 3.

### DETAILED DESCRIPTION

Various embodiments and aspects of the disclosure will be described with reference to details discussed below. The following description and drawings are illustrative of the disclosure and are not to be construed as limiting the disclosure. The Figures are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. In one non-limiting example, the terms “about” and “approximately” mean plus or minus 10 percent or less.

Unless defined otherwise, all technical and scientific terms used herein are intended to have the same meaning as commonly understood to one of ordinary skill in the art.

While polyammoniums have been extensively studied, there has been much less research on polyphosphoniums. Kanazawa et al. showed that polymeric phosphonium salts exhibited higher antibacterial activity compared to analogous polymeric ammonium salts [¹⁰] Ammonium based polymers have used separate hydrophobic and hydrophilic copolymers to adjust hemolytic activity.⁸ These ammonium based polymers exhibiting antibacterial properties have two competing issues that limit their antibacterial efficacy. Specifically, it has been observed that if the more hydrophobic the polymer is, the better it works, but are observed to lyse red blood cells more efficiently. Trying to counter this by introducing more hydrophilic components on the polymer does result in it killing fewer red blood cells, but this results in a decrease in the antibacterial activity of the resulting polymer.

The present disclosure avoids these competing forces by producing phosphorous based polymers in which hydrophilic substituents are attached directly on phosphorus. These modified polymers exhibit a decrease in red blood cell toxicity, but still exhibit very active antibacterial activity. This was observed with both the attachment of the hydroxyl substituents and the sugars.

Three (3) phosphorous based polymers have been prepared which exhibit increased antibacterial activity and decreased hemolytic activity. The structure of each of these three (3) polymers will now be illustrated and described, their method of synthesis and derivatives that may be synthesized that are contemplated to exhibit similar increased antibacterial activity and decreased hemolytic activity.

### 1. Poly(THPvbPCl)

Formula 1 below shows Poly(THPvbPCl), poly(tris(3-hydroxypropyl)(vinylbenzyl)phosphonium chloride).

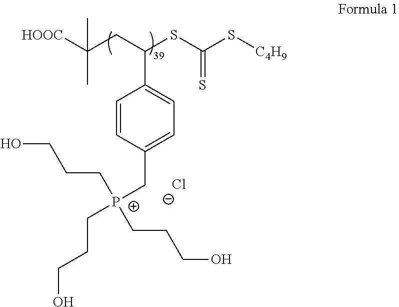

To produce Formula 1, Tris(hydroxyl) phosphine (0.749 g, 2.08 mmol), 2-(((butylthio)carbonothioyl)thio)-2-methylpropanoic acid (13.2 mg, 52.4 μmol), azobisisobutyronitrile (2.8 mg, 17.3 μmol), and dimethylformamide (5 mL) were combined in a Schlenk flask with a Suba Seal septum, and deoxygenated by bubbling N_{2(g)} through the solution for 30 minutes. The resulting solution was heated at 80° C. for 24 hours, then submerged in liquid N₂ to quench the polymerization. The resulting solution was dissolved in H₂O (5 mL) and dialyzed against H₂O using a regenerated cellulose dialysis membrane (molecular weight cut off 3.5 kg/mol) for 24 hours. The resulting solution was lyophilized, giving a yellow powder. Yield: 0.423 g, 56%. ¹H NMR (600 MHz, D₂O, δ): 7.24 (broad s), 6.73 (broad s), 3.83-3.43 (broad s), 2.44-2.06 (m), 1.93-1.71 (m), 1.59-1.42 (m), 1.41-1.24 (m), 0.88 (broad s); ³¹P{¹H} NMR (161 MHz, D₂O, δ): 33.23.

### Poly(THPvbPCl) Derivatives:

Formula 1A shown below is a generalized version of Formula 1 above are shown below and Formula 4 shown below are contemplated by the inventors to exhibit efficacious antimicrobial properties.

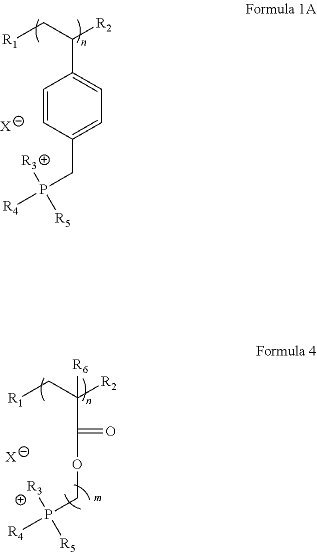

Formulas 1A and 4 are polymers from vinyl benzyl (styrenic) and (meth)acrylate polymerizable units where n can be 1 (monomer) to about 300, and m can be a carbon linker from C₁H₂ to C₁₈H₃₇. R₁ and R₂ can be any RAFT, ATRP, NMP, alkyl, aryl, ester, ether, carboxylic acid, halogen, or a hydrogen substituent. R₃, R₄, R₅ can be any combination of one, two, or three hydroxyl containing substituent with the remaining substituents being any combination of alkyl, aryl, halogen, carboxylic acid, ester. Or R₃, R₄, R₅ can be either an alpha or beta anomer with allyl ether, thioether, or propyl linked mannose, glucose, galactose, maltose, or sucrose substituent as one, two, or all three substituents in combination with any alkyl, aryl, halogen, carboxylic acid, ester. The anion, X⁻ can be any anionic halogen.
2. Formula 2 below shows poly(dihexyl(2,3,4,6-hydroxy-mannopyranyl)-1-oxy-propyl)vinylbenzylphosphonium chloride) (which is a mannose version),

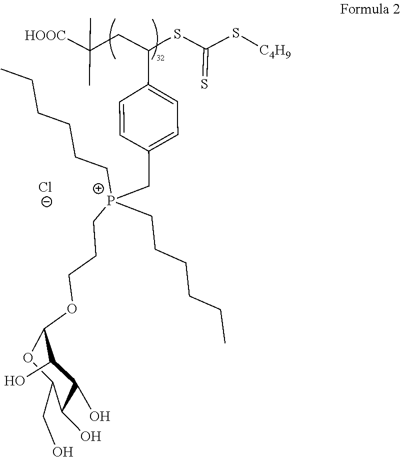

To produce Formula 2 ((2,3,4,6-Tetra-O-acetyl-manno-pyranyl)-1-oxy-allyl (4.23 g, 10.9 mmol), azobisisobutyronitrile (10 mg, 61 μmol), and CH₃CN (250 mL) was combined in an autoclave reactor, and purged with a N₂ flow for 10 minutes then charged with 550 kPa of PH_{3(g)}. The reaction was stirred at room temperature for 1 hour, recharged with 550 kPa PH_{3(g)}, stirred for one hour, and charged a third time with 550 kPa PH_{3(g)}. The reaction was then heated to 45° C. overnight. Once cooled to room temperature, the excess PH₃ was incinerated, and the reaction mixture was checked by ³¹P{¹H} NMR spectroscopy for primary phosphine and ¹H NMR spectroscopy for remaining olefin. If there was olefin functionality remaining, the PH₃ charging and heating process was repeated until any sign of secondary phosphine appeared. The sealed reaction was then transferred into a glovebox and the volatiles were removed in vacuo at 60° C.

The resulting oil was then combined in a pressure tube with 1-hexene (2.56 g, 30.8 mmol) and azobisisobutyronitrile (0.05 g, 0.3 mmol) under a N₂ atmosphere, and heated to 65° C. overnight. The reaction was transferred into a glovebox, where an aliquot was removed and checked by ³¹P{¹H} NMR spectroscopy for conversion to a tertiary phosphine (≈−30 ppm). Once all primary phosphine was converted to a tertiary phosphine, 4-vinylbenzyl chloride (1.8 g, 12 mmol) was added to the reaction mixture and it was stirred at room temperature (monitored by ³¹P{¹H} NMR spectroscopy).

Once quaternization was complete, volatiles were removed in vacuo, resulting in viscous orange oil. The product was purified using a methyl silyl functionalized silica plug,⁹ first eluting with Et₂O to remove uncharged organic by-products, followed by CH₃OH to elute the phosphonium salt. The solvent was removed in vacuo, yielding the product as an orange oil. Yield: 0.85 g, 11%. ¹H (600 MHz, CDCl₃, δ): 7.39-7.29 (m, 4H), 6.63 (dd, J=17.5 Hz, 11 Hz, 1H), 5.73 (d, J=17.6 Hz, 1H), 5.26-5.15 (m, 4H), 4.76 (broad s, 1H), 4.26-4.22 (m, 1H), 4.12-4.03 (m, 2H), 3.90 (broad s, 1H), 3.81 (broad s, 1H), 2.29 (broad s, 2H), 2.19 (broad s, 6H), 2.10-1.94 (m, 16H), 1.41 (broad s, 6H), 1.22 (broad s, 8H), 0.82 (m, 6H); ³¹P{¹H} (161 MHz, CDCl₃, δ): 32.33; ¹³C{¹H} (151 MHZ, CDCl₃, δ): 170.66, 170.07, 169.95, 169.56, 137.93, 135.73, 130.17, 127.41, 115.11, 97.61, 68.93 (m), 68.73, 67.29, 65.93, 62.41, 34.44, 30.93, 30.47, 30.37, 26.73 22.54, 22.28, 21.97, 21.58, 20.78, 20.64, 18.90, 18.53, 13.87; HRMS (ESI-TOF) m/z: Calcd for C₃₈H₆₀O₁₀P [M]⁺: 707.3924; Found 707.3922.

### Polymerization and Deprotection

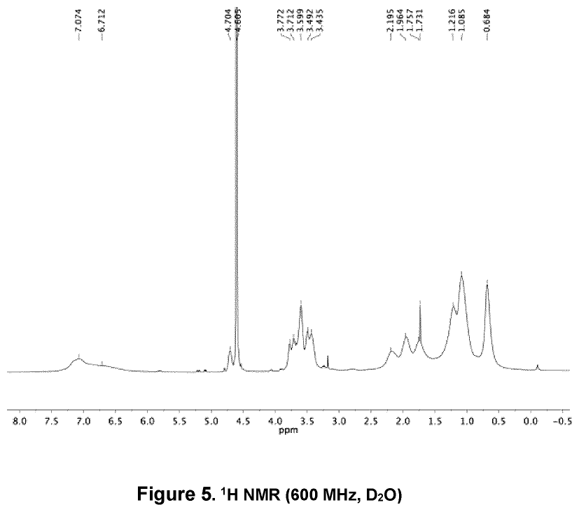

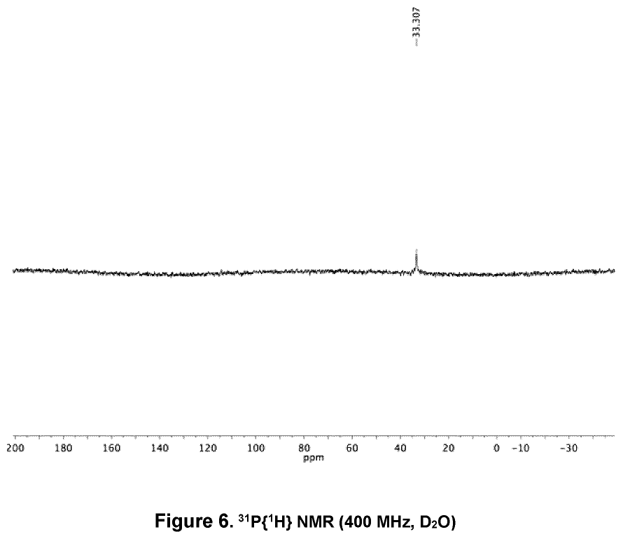

Dihexyl((manno-pyranyl)-1-oxy-propyl)vinylbenzylphosphonium chloride (0.219 g, 0.29 mmol), 2-(((butylthio)carbonothioyl)thio)-2-methylpropanoic acid (1.93 mg, 7.65 μmol), azobisisobutyronitrile (0.41 mg, 2.53 μmol), and 50/50 toluene/acetonitrile (4 mL) were combined in a Schlenk flask with a Suba Seal Septum and purged of oxygen by bubbling N_{2(g)} through the solution for 30 minutes. The resulting solution was heated to 80° C. for 20 hours, then submerged in liquid N₂ to quench to polymerization. Volatiles were then removed in vacuo and the polymer redissolved in a minimal amount of methanol (2 mL), dialyzed against methanol using a regenerated cellulose dialysis membrane (molecular weight cut off of 3.5 kg/mol) for 24 hours, with three changes of the dialysate. To the resulting solution, sodium methoxide was added (25 wt % solution, 0.319 g, 2.57 mmol), and the reaction mixture was stirred for 4 hours. The resulting solution was dialyzed against methanol containing DOWEX 5W80 acidic resin overnight, changing the dialysate and resin once. The resulting solution was concentrated in vacuo and giving a yellow oil. Yield: 0.126 g, 57%. The NMR results for Formula 2 are shown in FIGS. 5 and 6 which show: ¹H NMR (600 MHz, D₂O, δ): 7.07 (broad s), 6.71 (broad s), 4.70 (broad s), 4.60 (s), 3.77-3.43 (m), 2.19-1.73 (m), 1.21-1.08 (m), 0.68 (broad 5), ³¹P {¹H} NMR (161 MHz, CDCl₃, δ): 33.30.

3. Formula 3 below shows poly(dihexyl(2,3,4,6,-hydroxy-gluco-pyranyl)-1-oxy-propyl)vinylbenzylphosphonium chloride), (a Glucose derivative)

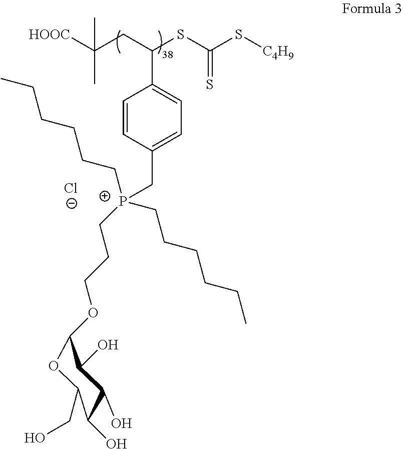

To produce Formula 3, ((2,3,4,6-Tetra-O-acetyl-gluco-pyranyl)-1-oxy-allyl (1.091 g, 2.81 mmol), azobisisobutyronitrile (0.03 g, 0.18 mmol), and CH₃CN (250 mL) were combined in an autoclave reactor and purged with a N₂ flow for 10 minutes, and then charged with 550 kPa of PH_{3(g)}. The reaction was stirred at room temperature for 1 hour, recharged with 550 kPa PH_{3(g)}, stirred for one hour, and charged a third time with 550 kPa PH_{3(g)}. The reaction was then heated to 45° C. for 24 hours. Once cooled to room temperature, the excess PH₃ was incinerated, and the reaction was transferred into a glovebox and volatiles were removed in vacuo at 60° C. Half of the resulting oil was combined in a pressure tube with 1-hexene (1.50 g, 18 mmol) and azobisisobutyronitrile (0.02 g, 0.12 mmol), under an N₂ atmosphere, and heated to 65° C. overnight. The reaction was brought into a glovebox and the reaction was checked by ³¹P{¹H} NMR spectroscopy for conversion to a tertiary phosphine (≈−30 ppm). Once all primary phosphine was converted to a tertiary phosphine, 4-vinylbenzyl chloride (0.50 g, 3.28 mmol) was added to the reaction mixture and stirred at room temperature for 4 hours. Quaternization was confirmed by ³¹P{¹H} NMR spectroscopy. Volatiles were then removed in vacuo, resulting in an orange viscous oil.

The product was purified using a methyl silyl functionalized silica plug,⁹ first eluting with Et₂O to remove all by-products, followed by CH₃OH to elute the desired product. The volatiles were removed in vacuo, yielding pure product as a yellow oil. Yield: 140 mg, 7%. ¹H (600 MHz, CDCl₃, δ): 7.39 (s, 4H), 6.70 (dd, J=17.6 Hz, 11 Hz, 1H), 5.76 (d, J=17.6, 1H), 5.40-5.11 (m, 4H), 4.25-4.03 (m, 6H), 3.77 (s, 2H), 3.50 (s, 2H), 2.55 (m, 2H), 2.39 (s, 4H), 2.52-1.99 (m, 12H), 1.90 (m, 2H), 1.45 (m, 6H), 1.26 (m, 8H), 0.87 (m, 6H), ³¹P{¹H} (161 MHz, CDCl₃, δ): 33.67; ¹³C {¹H} (151 MHZ, CDCl₃, δ): 170.57, 170.40, 170.17, 169.97, 137.88, 135.72, 130.33, 127.61, 127.22, 115.12, 96.46, 67.91 (m), 67.66, 67.42, 66.19, 61.62, 61.42, 31.29, 31.02, 30.52, 30.42, 22.30, 21.73, 20.77, 20.62, 19.06, 18.71, 13.88; HRMS (ESI-TOF) m/z: Calcd for C₃₈H₆₀O₁₀P [M]⁺: 707.3924; Found 707.3942.

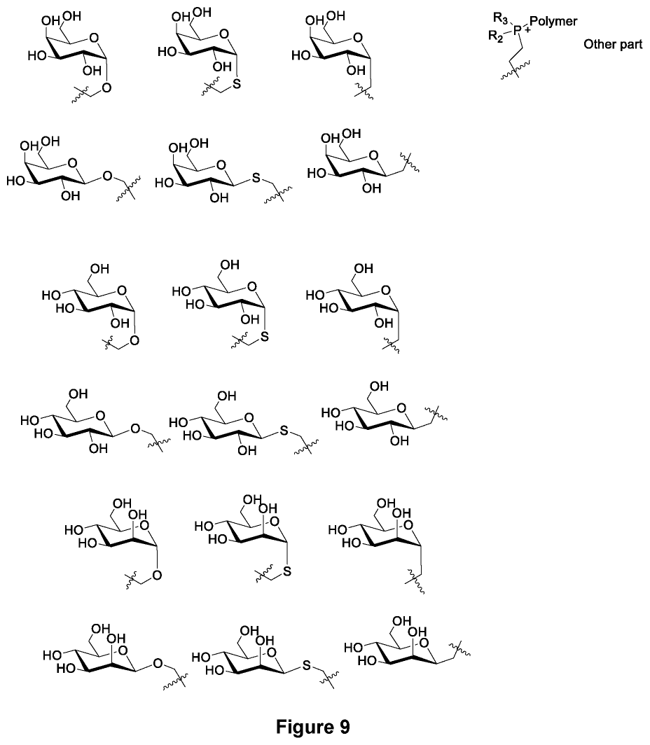

FIG. 9 shows examples of Galactose, Glucose and Mannose derivatives linked with Allyl ethers, Allyl thioethers, and C-allyl compounds.

### Polymerization and Deprotection

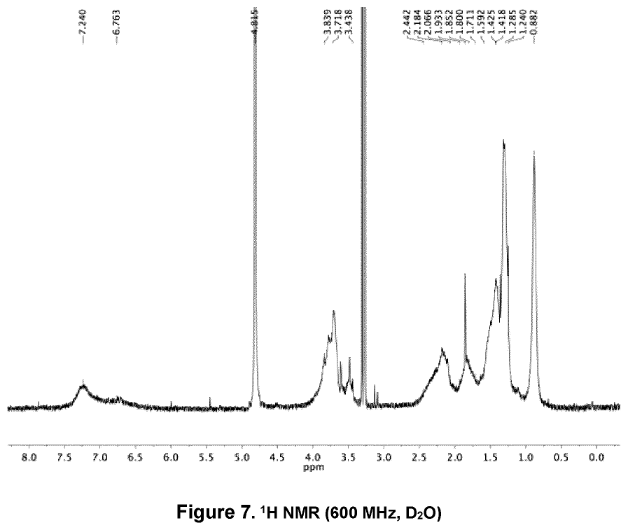

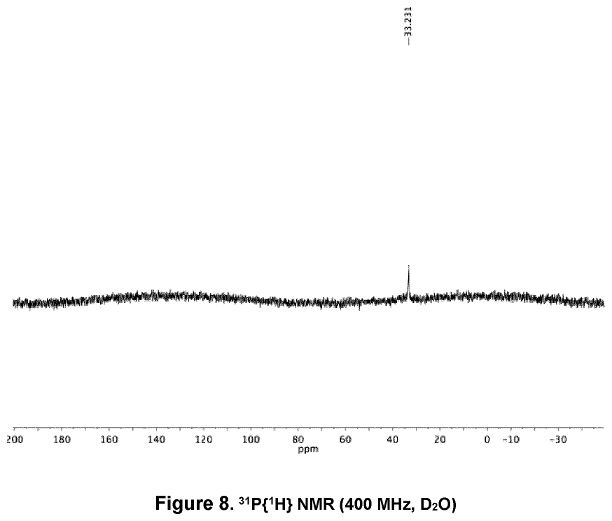

Dihexyl((gluco-pyranyl)-1-oxy-propyl)vinylbenzylphosphonium chloride (93 mg, 0.12 mmol), 2-(((butylthio)carbonothioyl)thio)-2-methylpropanoic acid (0.8 mg, 3.22 μmol), azobisisobutyronitrile (0.2 mg, 1.07 μmol), and 50/50 toluene/acetonitrile (2 mL) were combined in a Schlenk flask with a Suba Seal Septum, and deoxygenated by bubbling N_{2(g)} through the solution for 30 minutes. The resulting solution was heated to 80° C. for 20 hours, and then submerged in liquid N₂ to quench to polymerization. Volatiles were then removed in vacuo and the polymer was redissolved in a minimal amount of methanol (2 mL), and dialyzed against methanol using a regenerated cellulose dialysis membrane (molecular weight cut off of 3.5 kg/mol) for 24 hours with three changes of dialysate. To the resulting solution, sodium methoxide was added (25 wt % solution, 0.2 g, 6.45 mmol), and the reaction was stirred for 4 hours. The resulting solution was dialyzed against methanol containing DOWEX 5W80 acidic resin overnight, changing the dialysate and resin once. The resulting solution was concentrated in vacuo and give a yellow oil. Yield: 65 mg, 73%. The NMR results for Formula 3 are shown in FIGS. 7 and 8 which show: ¹H NMR (600 MHz, D₂O, δ): 7.24 (broad s), 6.73 (broad s), 3.83-3.43 (broad s), 2.44-2.06 (m), 1.93-1.71 (m), 1.59-1.42 (m), 1.41-1.24 (m), 0.88 (broad s); ³¹P{¹H} NMR (161 MHz, D₂O, δ): 33.23.

Incorporating these phosphorous based polymers exhibiting antibacterial properties and decreased hemolytic activity will be useful in medical applications, particularly internal medicine applications.

While the discussion is for the above three (3) molecules of Formulas 1 to 3, it is clear that other embodiments can have the functional group or groups that are made up of the following, mono, oligo, poly saccharide (alpha or beta anomers, D or L enantiomers), alkyl alcohol, aryl alcohol, carboxylic acid, ketone, ester, (cyclic)ether, glycerol, epoxide, polyethylene glycol/oxide, sulfide, alkyl thiol, aryl thiol, sulfone, sulfonic acid, (iso)cyanate, amide, amine, carbamate, nitrile, nitro, amino acids, peptides, phosphate, phosphonate, phosphine oxide, phosphite, phosphodiesters. Or any functional group that is known to have an interaction with a target bacteria as a substituent that does or does not insert into the cell membrane.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

(1) Ikeda, T.; Yamaguchi, H.; Tazuke, S. Antimicrob. Agents Chemother. 1984, 26, 139-144.
(2) Ilker, M. F.; Nüsslein, K.; Tew, G. N.; Coughlin, E. B. J. Am. Chem. Soc. 2004, 126, 15870-15875.
(3) Sellenet, P. H.; Allison, B.; Applegate, B. M.; Youngblood, J. P. Biomacromolecules 2007, 8, 19-23.
(4) Mowery, B. P.; Lee, S. E.; Kissounko, D. A.; Epand, R. F.; Epand, R. M.; Weisblum, B.; Stahl, S. S.; Gellman, S. H. J. Am. Chem. Soc. 2007, 129, 15474-15476.
(5) Allison, K. R.; Brynildsen, M. P.; Collins, J. J. Nature 2011, 473, 216-220.
(6) Lin, C. C.; Yeh, Y. C.; Yang, C. Y.; Chen, C. L.; Chen, G. F.; Chen, C. C.; Wu, Y. C. J. Am. Chem. Soc. 2002, 124, 3508-3509.
(7) Bilková, A.; Paulovičová, E.; Paulovičová, L.; Poláková, M. Monatsh Chem 2015, 146, 1707-1714.
(8) Engler, A. C.; Tan, J. P. K.; Ong, Z. Y.; Coady, D. J.; Ng, V. W. L.; Yang, Y. Y.; Hedrick, J. L. Biomacromolecules 2013, 14, 4331-4339.
(9) Panne, P.; Fox, J. M. J. Am. Chem. Soc. 2007, 129, 22-23.
(10) A. Kanazawa, T. Ikeda, T. Endo, J. Polym. Sci. Part A Polym. Chem. 1993, 31,335.

1. A phosphorous based polymer derivative of poly(tris(3-hydroxypropyl)(vinylbenzyl)phosphonium chloride) shown in Formula 1A exhibiting antibacterial properties, 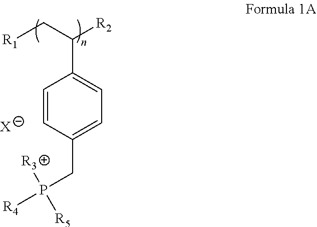
wherein n is an integer in a range from 1 (monomer) to about 300, wherein R₁ and R₂ are any of RAFT, ATRP, NMP, alkyl, aryl, ester, ether, carboxylic acid, halogen, or a hydrogen substituent, wherein R₃, R₄, R₅ can be any combination of one, two, or three hydroxyl containing substituent with the remaining substituents being any combination of alkyl, aryl, halogen, carboxylic acid, ester, or wherein R₃, R₄, R₅ can be either an alpha or beta anomer with allyl ether, thioether, or propyl linked mannose, glucose, galactose, maltose, or sucrose substituent as one, two, or all three substituents in combination with any alkyl, aryl, halogen, carboxylic acid, ester, and where the anion X⁻ can be any anionic halogen.

2. A phosphorous based polymer exhibiting antibacterial activity, comprising poly(tris(3-hydroxypropyl)(vinylbenzyl)phosphonium chloride) shown in Formula 1,

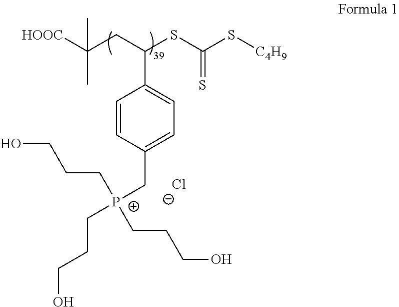

3. A phosphorous based polymer exhibiting antibacterial activity poly(dihexyl(2,3,4,6-hydroxy-mannopyranyl)-1-oxy-propyl)vinylbenzylphosphonium chloride) shown in Formula 2 (Mannose version),

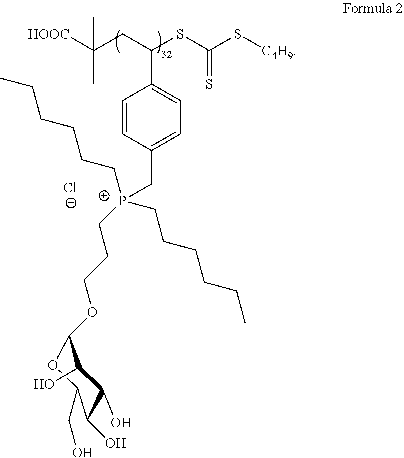

4. A phosphorous based polymer exhibiting antibacterial activity, comprising poly(dihexyl(2,3,4,6,-hydroxy-gluco-pyranyl)-1-oxy-propyl)vinylbenzylphosphonium chloride) shown in Formula 3 (Glucose derivative),

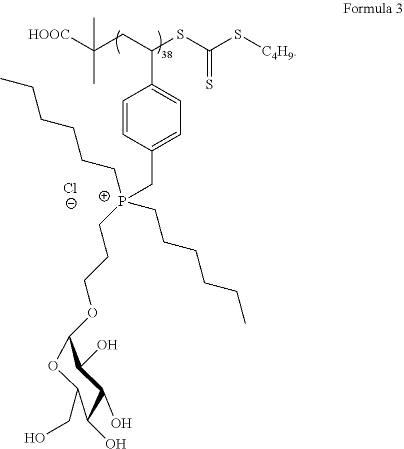

5. A phosphorous based polymer derivative of poly(tris(3-hydroxypropyl)(acryloyl)phosphonium chloride) shown in Formula 4 exhibiting antibacterial properties 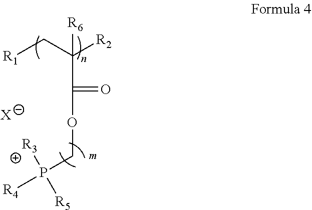
wherein n is an integer in a range from 1 (monomer) to about 300, m is a carbon linker from C₁H₂ to C₁₈H₃₇, wherein R₁ and R₂ are any of RAFT, ATRP, NMP, alkyl, aryl, ester, ether, carboxylic acid, halogen, or a hydrogen substituent, wherein R₃, R₄, R₅ can be any combination of one, two, or three hydroxyl containing substituent with the remaining substituents being any combination of alkyl, aryl, halogen, carboxylic acid, ester, or wherein R₃, R₄, R₅ can be either an alpha or beta anomer with allyl ether, thioether, or propyl linked mannose, glucose, galactose, maltose, or sucrose substituent as one, two, or all three substituents in combination with any alkyl, aryl, halogen, carboxylic acid, ester, and where the anion X⁻ can be any anionic halogen.
